(19) United States
(12) Patent Application Publication
(10) Pub. No.: US 2025/0125696 A1
(43) Pub. Date: Apr. 17, 2025

(54) MODULAR ROTOR DESIGN OF AN E-MOTOR

(71) Applicant: BorgWarner Inc., Auburn Hills, MI (US)

(72) Inventors: Cong Ma, Fishers, IN (US); Steven C. Burton, Anderson, IN (US); Josh B. Lahrman, New Palestine, IN (US)

(21) Appl. No.: 18/913,105

(22) Filed: Oct. 11, 2024

Related U.S. Application Data
(60) Provisional application No. 63/589,899, filed on Oct. 12, 2023.

(51) Int. Cl. H02K 15/03; H02K 1/276

(52) U.S. Cl. CPC H02K 15/03; H02K 1/276; H02K 2201/06

(57) ABSTRACT

A rotor of a motor and method of assembly. The rotor includes a shaft hub. A plurality of ministacks is disposed along a length of the shaft hub to form a stack having a stack length. Each ministack has a same length and the stack length is less than a hub length of the shaft hub. The rotor can be placed in a stator core to assemble the motor.

### CROSS REFERENCE TO RELATED APPLICATIONS

This application claims the benefit of an earlier filing date from U.S. Provisional Application Ser. No. 63/589,899 filed Oct. 12, 2023, the entire disclosure of which is incorporated herein by reference.

### BACKGROUND

Different vehicles often have different operational requirements, such as with respect to torque, performance, efficiency, etc. To achieve these different requirements, some motors may be designed with different lengths: shorter motors for vehicles with lower operational requirements and longer motors for vehicle with higher operational requirements. Manufacturing motors with different lengths increases the cost per motor due to different design and manufacturing requirements.

### SUMMARY

Disclosed herein is a method of assembling a motor. A first ministack is assembled including a selected number of laminations. At least a second ministack is assembled including the selected number of laminations. The first ministack is assembled onto a shaft hub at a first longitudinal location at a first shaft end of the shaft hub, the shaft hub extending from the first shaft end to a second shaft end over a hub length. The at least the second ministack is assembled onto the shaft hub, wherein the first ministack and the at least the second ministack form a stack having a stack length less than the hub length. The rotor is placed in a stator core to assemble the motor.

Also disclosed herein is a method for assembling a first rotor and a second rotor. A plurality of ministacks having a same length is assembled. A first subset of ministacks is assembled onto a first shaft hub of the first rotor having a first shaft length to form a first stack having a first stack length, the first shaft hub having a first hub length. A second subset of ministacks onto a second shaft hub of the second rotor having a second shaft length to form a second stack having a second stack length, the second shaft hub having a second hub length the same as the first hub length, wherein at least one of the first stack length is less than the first shaft length and the second stack length is less than second shaft length.

Also disclosed is a rotor of a motor. The rotor includes a shaft hub and a plurality of ministacks disposed along a length of the shaft hub to form a stack having a stack length, wherein each ministack has a same length and wherein the stack length is less than a hub length of the shaft hub.

### BRIEF DESCRIPTION OF THE DRAWINGS

The following descriptions should not be considered limiting in any way. With reference to the accompanying drawings, like elements are numbered alike:

FIG. 1 is a schematic diagram of a motor, in an exemplary embodiment;

FIG. 2 is a perspective view of the stator in an illustrative embodiment;

FIG. 3 is a perspective view of a shaft hub of the rotor of FIG. 1, in an illustrative embodiment;

FIG. 4 shows a perspective view of a ministack in an exemplary embodiment;

FIG. 5 shows a perspective view of the ministack with magnets disposed in the pockets;

FIG. 6 shows a first rotor in an embodiment;

FIG. 7 shows a second rotor in an embodiment;

FIG. 8 shows a third rotor in an embodiment;

FIG. 9 is a flowchart of a method for generating a family of rotors using the methods disclosed herein;

FIG. 10 show a side cross-sectional view of a motor, in an illustrative embodiment; and

FIG. 11 show a side cross-sectional view of another motor, in an illustrative embodiment.

### DETAILED DESCRIPTION

A detailed description of one or more embodiments of the disclosed apparatus and method are presented herein by way of exemplification and not limitation with reference to the Figures.

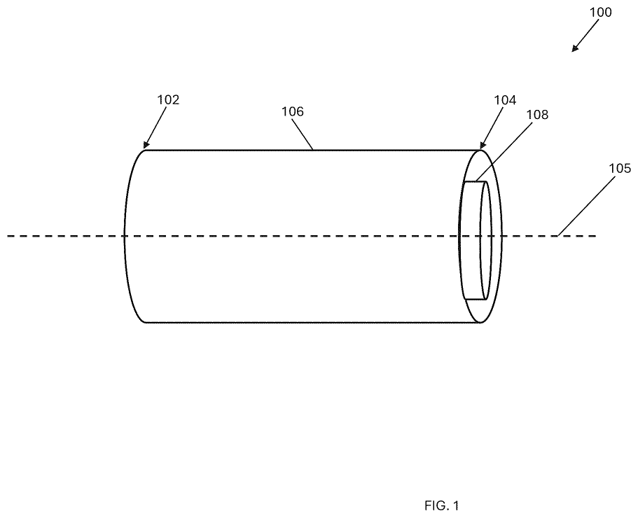

FIG. 1 is a schematic diagram of a motor 100, in an exemplary embodiment. The motor 100 extends from a first end 102 to a second end 104 along a longitudinal axis 105. The motor 100 includes a stator 106 and a rotor 108 that rotates within the stator 106. The stator 106 forms a hollow cylinder within which the rotor 108 rotates.

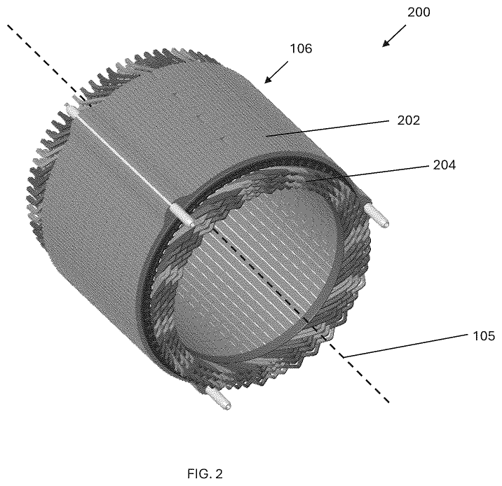

FIG. 2 is a perspective view 200 of the stator 106 in an illustrative embodiment. The stator 106 includes a stator core 202 (or stator housing) extending along the longitudinal axis 105 and a set of wires 204 disposed along an inner wall of the stator 106.

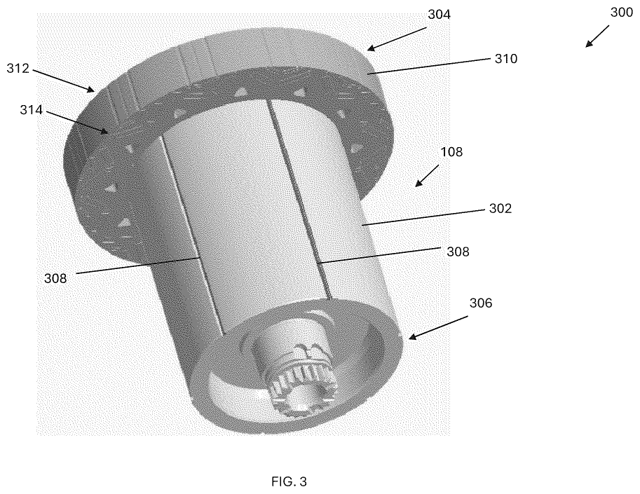

FIG. 3 is a perspective view 300 of a shaft hub 302 of the rotor 108 of FIG. 1, in an illustrative embodiment. The shaft hub 302 extends along the longitudinal axis 105 from a first shaft end 304 to a second shaft end 306. The shaft hub 302 includes one or more slots 308 that extend longitudinally. The one or more slots 308 allow one or more ministacks to slide over the shaft hub 302 during manufacture of the rotor 108. As shown in FIG. 3, a ministack 310 is located at one end the shaft hub 302. The ministack 310 extends from a first ministack end 312 to a second ministack end 314. When placed on the shaft hub 302, the first ministack end 312 is located at the first shaft end 304 and the second ministack end 314 is located at a selected distance form the first shaft end 304. A spacer (not shown) can be placed on the stator core (202, FIG. 2) to extend across the remainder of the shaft hub 302, thereby filling a gap extending from the second ministack end 314 to the second shaft end 306, thus securing the ministack 310 in place on the shaft hub 302.

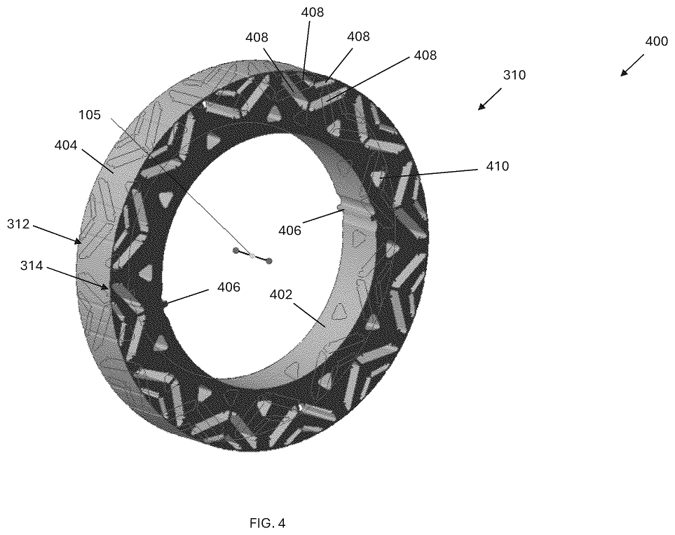

FIG. 4 shows a perspective view of a ministack 310 in an exemplary embodiment, The ministack 310 is constructed by assembling a plurality of laminations side by side against each other. Each lamination is a thin disc with various cutaway hole in the disc. The laminations are bonded, interlocked or welded to each other to form a longitudinally extending ministack. When the laminations are assembled to form the ministack, the cutaway regions align to from a plurality of pockets and cooling channels in the ministack 310.

The ministack 310 forms a ring extending from first ministack end 312 to second ministack end 314 along the longitudinal axis. Each ministack 310 has an inner radial surface 402 and an outer radial surface 404. The inner radial surface 402 includes one or more keys 406 that are circumferentially aligned with the one or more slots 308 of the shaft hub 302.

A central hole of the disc has a diameter about equal to an outer diameter of the shaft hub 302. In an embodiment, a lamination has a thickness of about 0.025 millimeters. In other embodiments, the lamination can have a thickness of about 0.25 millimeters. For illustrative purposes, the ministack 310 shows pockets 408 as well as a cooling passage 410 for flow of a cooling fluid through the ministack. In various embodiments, 145 laminations are bonded to each other per ministack, resulting in a ministack having a longitudinal length of 36.4 millimeters.

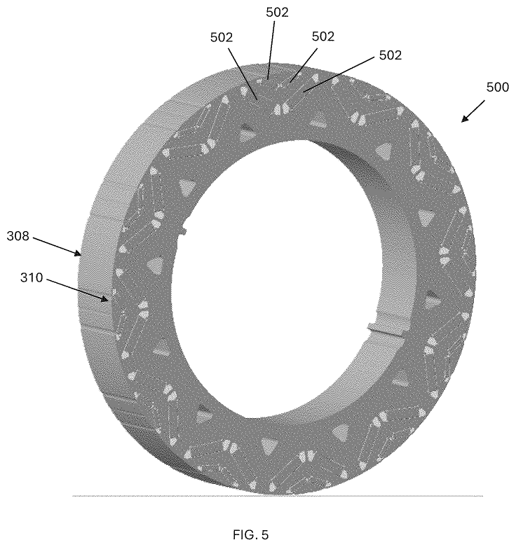

FIG. 5 shows a perspective view 500 of the ministack 310 with magnets 502 disposed in the pockets 408. The magnets 502 generally have a length that is equal to, or slightly less than, an axial length of the ministack 309. The magnets 502 can be bonded within the pockets 408 using various adhesive materials and/or devices, such as an adhesive, an epoxy, a resin, a plastic or a mechanical connection.

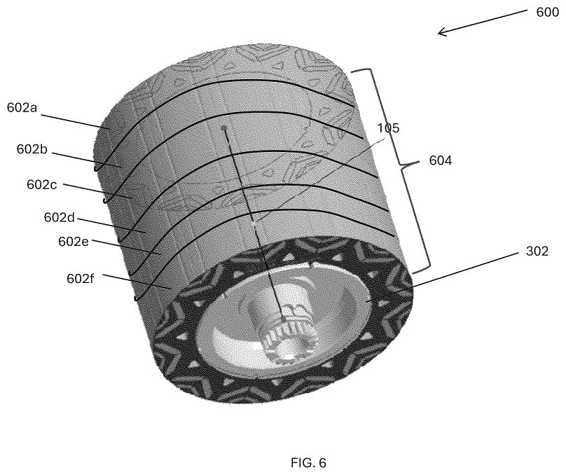

FIG. 6 shows a first rotor 600 in an embodiment. The first rotor 600 includes a plurality of ministacks 602a-602f extending along an entire hub length of the shaft hub 302. For illustrative purposes, six ministacks are disposed on the shaft hub. The first ministack 602a is assembled against the first shaft end 304 of the shaft hub 302, placing it at a first longitudinal location along the shaft hub at the first shaft end. The second ministack 602b is then assembled against the first ministack 602a placing it at a second longitudinal location along the shaft hub, and so on until all of the ministacks are attached to the shaft hub 302, thereby forming a first stack 604 having a first stack length. In general, a stack is the plurality of ministacks placed axially against each other and a stack length is an axial length of the stack. For the first stack 604, the first stack length is measured from a first end of the first ministack 602a to a second end of the last ministack (e.g., sixth ministack 620f). The length of each ministack is about 36.4 mm. As a result, a first stack length for the first stack 604 is 218.4 mm.

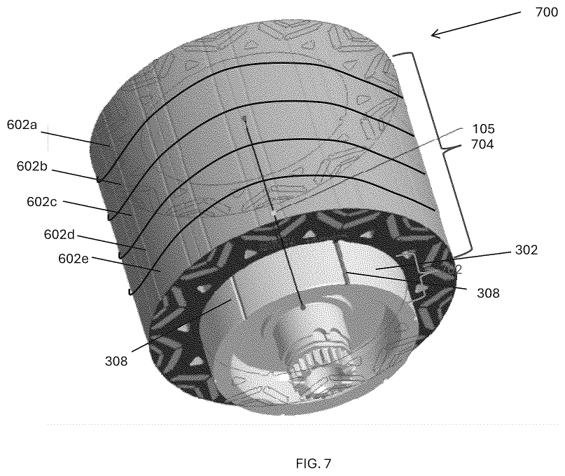

FIG. 7 shows a second rotor 700 in an embodiment. The second rotor 700 includes five ministacks 602a-620d disposed along the shaft hub 302. The first ministacks 602a is assembled against the first shaft end 304 of the shaft hub 302. The second ministack 602b is then assembled against the first ministack 602a, and so on until all five of the ministacks are attached to the shaft hub 302 to form a second stack 704. For the second rotor 700, the second stack length is measured from a first end of the first ministack 602a to a second end of the fifth ministack 620e. The second stack 704 has a stack length of 182 mm and is 36.4 mm shorter than the first stack length of the first stack 604. A spacer (not shown) can be placed on the stator core (202, FIG. 2) to fill an axial gap 702 between the second end of the fifth ministack 602e and the second shaft end 306. The spacer can have a same axial length as a ministack.

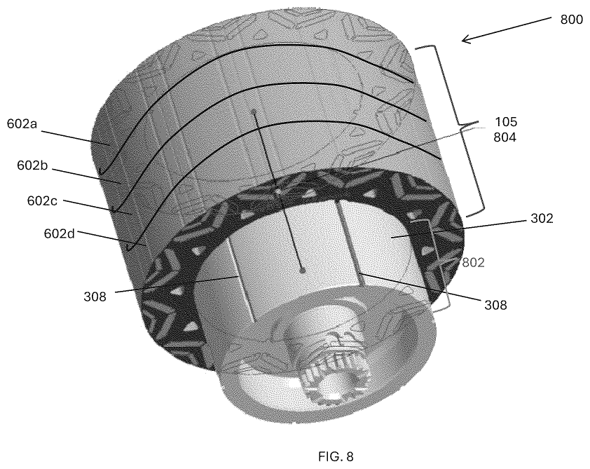

FIG. 8 shows a third rotor 800 in an embodiment. The third rotor 800 includes four ministacks 602a-602d disposed along the shaft hub 302. The ministacks are assembled onto the shaft hub 302 in the same manner as disclosed herein with respect to FIGS. 6 and 7, thereby forming a third stack 804. For the third rotor 800, the third stack length is measured from a first end of the first ministack 602a to a second end of the fourth ministack 620d. The stack 804 has a third stack length of 145.6 mm. A spacer having an axial length of two ministacks can be placed on the stator core (202, FIG. 2) to fill an axial gap 802 between the second end of the fourth ministack 602d and the second shaft end 306. Alternatively, two spacers, each having an axial length of one ministack, can be placed to fill the space between the second end of the fourth ministack 602d and the second shaft end 306.

Any of the first rotor 600, second rotor 700 and third rotor 800 can be configured with a non-zero skew angle in the rotor to reduce torque ripple of the motor. To create a non-zero skew angle, the ministacks are assembled at slightly different rotational angles to one another. This causes the magnets of the rotor to be skewed with respect to each other. In an embodiment, the slots of the shaft hub are longitudinally straight and each ministack can have their keys are different angles along the inner wall of the disk to produce the skew angle.

Each ministack can thereby be assembled on to the shaft hub at varying rotational angles to create the skew effect. For the first rotor 600, the skew is a 6-step skew. For the second rotor, the skew is a 5-step skew. For the third rotor, the skew is a 4-step skew. In other embodiments, the rotor can be assembled with no skew to the ministacks. In this embodiment, all mini stacks for all three rotor assemblies can be assembled onto their respective shaft hubs at a same rotational angle.

In general, ministacks are separated into at least a first subset of ministacks and a second subset of ministacks. The first subset of ministacks are used to manufacturing a first rotor having a first stack length and a second subset of ministacks are used to manufacture a second rotor having a second stack length. The number of ministacks in the first subset can be different from the number of ministacks in the second subset.

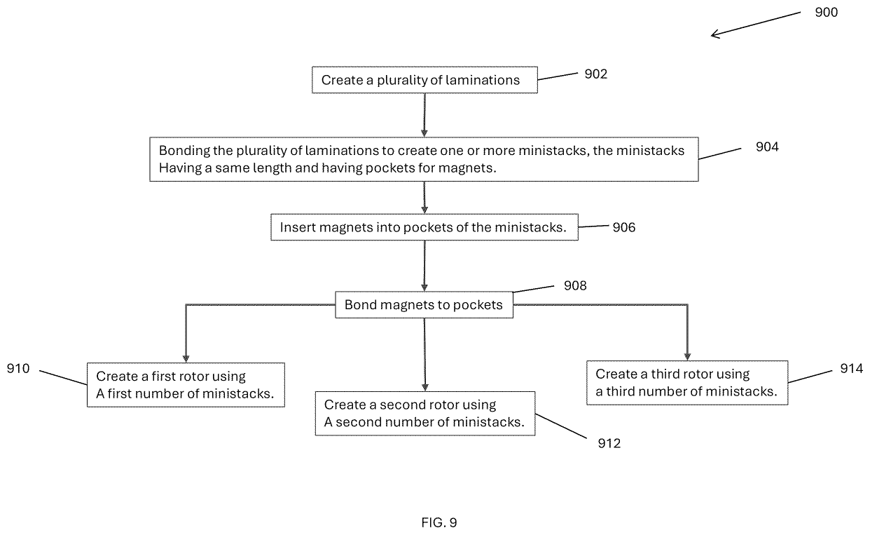

FIG. 9 is a flowchart 900 of a method for generating a family of rotors using the methods disclosed herein. In box 902, laminations are obtained for building a desired number of ministacks. In an embodiment, the desired number is 15 mini stacks. In box 904, the laminations are bonded or welded to form the desired number of mini stacks, with each ministack having a same length. Each ministack has at least one pocket for holding a magnet. In box 906, magnets are inserted into the pockets of each mini stack. The lengths of the magnets are about equal to the length of one ministack. In box 908, each magnet is affixed to each pocket via an adhesive, epoxy, resin, plastic or mechanical connection. Rotors of different axial lengths are created in boxes 910, 912 and 914.

In box 910, n ministacks are sequentially assembled onto a first shaft hub to create the first rotor 600 having a first stack 604 with a first stack length. In box 912, m ministacks are sequentially assembled onto a second shaft hub to assemble a second rotor 700 having a second stack with a second stack length. In box 914, p ministacks are sequentially assembled onto a third shaft hub to assemble a third rotor 800 having a third stack with a third stack length.

In one embodiment, n=6, m=5 and p=4 and thus, the first rotor has a first stack including 6 ministacks, the second rotor has a second stack including 5 ministacks and the third rotor has a third stack including 4 ministacks. However, n, m and p can be any numbers distinct from one another, such that the resulting stacks made from the n, m, and p ministacks, respectively, do not exceed the hub length of the shaft hub. In addition, the methods disclosed herein contemplate manufacture of only a first rotor having m ministacks and a second rotor having n ministacks, where m/n.

The first rotor can be placed within a first stator core to form a first motor. The second rotor can be placed within a second stator core to form a second motor. The third rotor can be placed within a third stator core to form a third motor. The first stator core, second stator core and third stator core can have the same axial length or stator length.

For all three shaft hubs, the assembly and assembling process are the same. In various embodiments, the ministacks can be thermally fit to the shaft hub, thereby reducing cupping of the ministacks. In addition, cupping can be reduced or eliminated by full-face bonding the laminations of the ministack to each other. With ministacks that do not cup, the mini stacks can be assembled on the shaft hub 302 without bonding between each mini stack. For further rigidity, each mini stack can be bonded (e.g., spot bonded or full faced bonded) to each other mini stack.

Although the ministacks presented herein have a length of 36.4 mm, this is provided only for illustrative purposes. The ministacks can have any length desired.

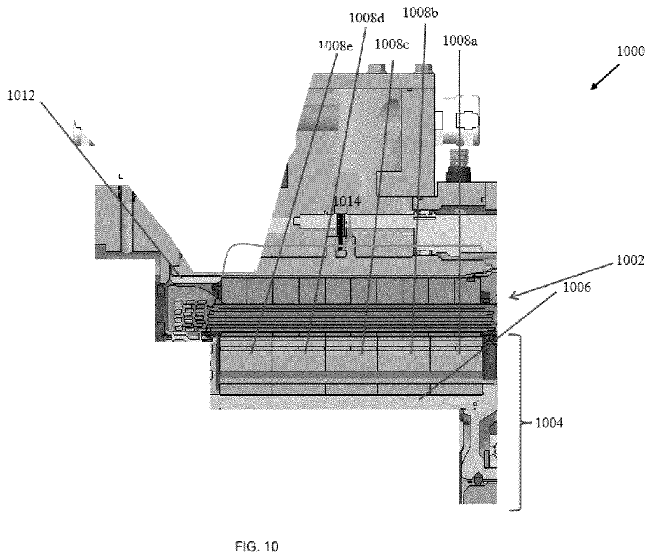

FIG. 10 show a side cross-sectional view of a motor 1000, in an illustrative embodiment. The motor 1000 includes a stator core 1002 and a rotor 1004. The rotor 1004 includes a rotor hub 1006 and a plurality of ministacks 1008a-1008e disposed along the rotor hub 1006. The plurality of ministacks 1008a-1008e leave a gap 1010 at an end of the rotor hub 1006. A spacer 1012 is disposed in the gap 1010 and is a member of the stator core 1002. An effective stator 1014 is a section of the stator core 1002 that is equivalent to the extent of the stack (e.g., plurality of ministacks 1008a-1008e). The length of the stator core 1002 minus the length of the spacer 1012 defines an effective length of the effective stator 1014 (effective stator length). For the motor 1000, the spacer 1012 is the length of one ministack. For other motors having a different number of ministacks, the spacer 1012 can be of an appropriate length (i.e., the length of multiple ministacks), thereby changing the effective stator.

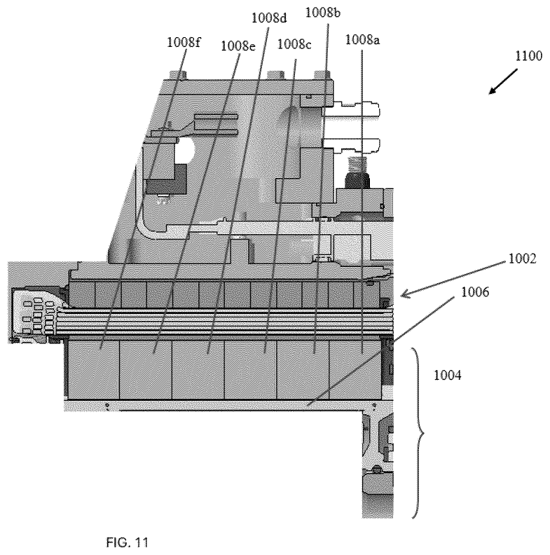

FIG. 11 show a side cross-sectional view of another motor 1100, in an illustrative embodiment. The plurality of ministacks 1008a-1008f extends to the end of the rotor hub 1006. Thus, no spacer is included in motor 1100. The length of the effective stator of FIG. 11 is the same as the length of the stator core. While the length of the stator core is the same in FIG. 10 and FIG. 11, the length of the effective stator of FIG. 10 is less than the length of the effective stator of FIG. 11.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method of assembling a motor, comprising:
assembling a first ministack including a selected number of laminations;
assembling at least a second ministack including the selected number of laminations;
assembling the first ministack onto a shaft hub at a first longitudinal location at a first shaft end of the shaft hub, the shaft hub extending from the first shaft end to a second shaft end over a hub length;
assembling the at least the second ministack onto the shaft hub, wherein the first ministack and the at least the second ministack form a stack having a stack length less than the hub length; and
placing the rotor in a stator core to assemble the motor.

2. The method of claim 1, further comprising one of: (i) assembling four ministacks onto the shaft hub; (ii) assembling five ministacks onto the shaft hub; and (iii) assembling six ministacks onto the shaft hub.

3. The method of claim 1, further comprising disposing a spacer on the stator core to fill an axial gap between the second ministack and the second shaft end of the shaft hub.

4. The method of claim 1, further comprising assembling the first ministack and the second ministack onto the shaft hub to have a non-zero skew angle between the first ministack and the second ministack.

5. The method of claim 1, further comprising disposing a first magnet into a first pocket of the ministack and disposing a second magnet into a second pocket of the second ministack.

6. The method of claim 3, wherein the stator core defines an effective stator having an effective stator length that is a length of the stator core minus a length of the spacer, wherein the effective stator length same as the stack length.

7. The method of claim 1, wherein the first ministack and the second ministack include a same number of laminations.

8. A method for assembling a first rotor and a second rotor, comprising:
assembling a plurality of ministacks having a same length;
assembling a first subset of ministacks onto a first shaft hub of the first rotor to form a first stack having a first stack length, the first shaft hub having a first hub length; and
assembling a second subset of ministacks onto a second shaft hub of the second rotor to form a second stack having a second stack length, the second shaft hub having a second hub length the same as the first hub length, wherein the first stack length is less than the second stack length.

9. The method of claim 8, wherein at least one of the first subset and the second subset includes one of: (i) four ministacks; (ii) five ministacks; and (iii) six ministacks.

10. The method of claim 8, wherein the first stack length of the first stack is less than a first hub length of the first shaft hub, further comprising filling an axial gap between the first stack and an end of the first shaft hub with a spacer.

11. The method of claim 8, further comprising at least one of: (i) assembling the first subset onto the first rotor stack with a non-zero skew angle therebetween; and (ii) assembling the first subset onto the first rotor stack with no skew angle.

12. The method of claim 8, wherein each ministack of the plurality of ministacks includes a magnet disposed within a pocket of the ministack.

13. The method of claim 8, further comprising placing the first rotor within a first stator core and the second rotor within a second stator core, wherein a first effective length of a first effective stator of the first stator core is the same as the first stack length and a second effective length of a second effective stator of the second stator core is the same as the second stack length.

14. The method of claim 8, wherein each ministack includes a same number of laminations.

15. A rotor of a motor, comprising:
a shaft hub; and
a plurality of ministacks disposed along a length of the shaft hub to form a stack having a stack length, wherein each ministack has a same length and wherein the stack length is less than a hub length of the shaft hub.

16. The rotor of claim 15, wherein the plurality of ministacks includes one of: (i) four ministacks; (ii) five ministacks; and (iii) six ministacks.

17. The rotor of claim 15, wherein the shaft hub is disposed in a stator core, further comprising a spacer disposed on the stator core to fill an axial gap between the stack and an end of the shaft hub.

18. The rotor of claim 15, wherein the plurality of ministacks includes one of: (i) a first ministack and a second ministack having a non-zero skew angle therebetween; and (ii) the first ministack and the second ministack having no skew angle.

19. The rotor of claim 15, wherein each of the plurality of ministacks includes a pocket having a magnet disposed therein.

20. The rotor of claim 15, wherein each ministack includes a same number of laminations.
